(19) United States
(12) Patent Application Publication
(10) Pub. No.: US 2008/0170403 A1
(43) Pub. Date: Jul. 17, 2008

(54) System and Method for Optimized Visualization on a Display Window

(76) Inventor: Vladimir Gurevich, Stony Brook, NY (US)

Correspondence Address: FAY KAPLUN & MARCIN, LLP, 150 BROADWAY, SUITE 702, NEW YORK, NY, 10038, US

(21) Appl. No.: 11/742,338

(22) Filed: Apr. 30, 2007

Related U.S. Application Data
(60) Provisional application No. 60/884,635, filed on Jan. 12, 2007.

(51) Int. Cl. F21V 9/00; G02B 27/02

(52) U.S. Cl. 362/319; 359/614

(57) ABSTRACT

A system and method optimizes a visualization of a display of a mobile device. The mobile device comprises a housing, a display, and an adaptive device. The display is situated at least partially in an opening of the housing. The adaptive device is disposed at least partially one of within the housing and in the opening. The adaptive device has a property to improve a visibility of the display. The property is related to an ambient lighting condition.

### PRIORITY CLAIM

This application claims the priority to the U.S. Provisional Application Ser. No. 60/884,635, entitled “Display Window for Optimized Visualization,” filed Jan. 12, 2007. The specification of the above-identified application is incorporated in its entirety herewith by reference.

### FIELD OF THE INVENTION

The present invention relates generally to a display window for a mobile device.

### BACKGROUND

A mobile device may be used in a variety of environments. The variety of environments may have a wide range of ambient lighting conditions. For example, one environment may have low ambient light such as an electrical closet or a warehouse. Another environment may have high ambient light such as an outdoor usage area or a shopping center. A mobile device may include a display to provide a visual interface for interactions with a user. The interactions may be to display data or receive input pertaining to a functionality of the mobile device. Those skilled in the art will understand that the level of ambient light affects how the user is able to view the display. For example, in areas of low ambient light, the user may be unable to distinguish any images or words shown on the display. In areas of high ambient light, the display may be susceptible to high reflection or glare, also disabling the user from distinguishing the content of the display. Conventional mobile devices may incorporate means of alleviating these conditions such as a brim providing a shade in high ambient light or a backlight in low ambient light. However, these means do not optimize the content viewed on the display and may inadvertently diminish the viewing capacity of the data on the display. For example, the brim may cause the display to be too dark or the backlight may cause the data on the display to be hazy.

Furthermore, with advances in mobile device technology, the overall size of the mobile device is decreasing, thereby decreasing the size of the display. As the display size decreases, issues regarding clarity of the content shown may arise. Active matrix displays (AMD) may provide high contrast but draw a significant amount of energy from a portable power supply (e.g., battery). AMDs also involve high costs. Passive matrix displays (PMD) are less costly and may provide good contrast in reflection mode but the picture contrast is decreased when a backlight is activated. For example, in low cost monochrome displays, LCD contrast is optimized for a relatively narrow optical band, approximately 495-570 nm (i.e., green). Furthermore, white backlights are preferred due to the high power efficiency. White LEDs have a large blue component that is not controlled by the liquid crystal of LCDs, thereby making black elements appear blue. As a result, picture contrast is decreased. However, PMDs are preferred over AMDs for the low cost and efficiency.

### SUMMARY OF THE INVENTION

A mobile device comprising a housing, a display, and an adaptive device. The display is situated at least partially in an opening of the housing. The adaptive device is disposed at least partially one of within the housing and in the opening. The adaptive device has a property to improve a visibility of the display. The property is related to an ambient lighting condition.

### BRIEF DESCRIPTION OF THE DRAWINGS

FIG. 1 shows a top view of a mobile device according to an exemplary embodiment of the present invention.

FIG. 2 shows a perspective view of the mobile device of FIG. 1.

FIG. 3 shows a top view of a mobile device according to another exemplary embodiment of the present invention.

FIG. 4 shows a first inner view of the mobile device of FIG. 1.

FIG. 5 shows a second inner view of the mobile device of FIG. 3.

FIG. 6a shows a third inner view of the mobile device of FIG. 1.

FIG. 6b shows a different configuration for the third inner view of FIG. 6a.

FIG. 7 shows a fourth inner view of the mobile device of FIG. 1.

FIG. 8 shows a method for optimizing visualization according to an exemplary embodiment of the present invention.

FIG. 9 shows a graph plotting power versus wavelength when using an adapted display according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention describe an adapted display that optimizes a viewing capability of a display for a mobile device (e.g., computing device, personal computer, laptop, pager, mobile device, cell phone, radio frequency identification device, scanner, etc.). According to a first exemplary embodiment of the present invention, data of a display may be seen through a window that may adapt to various ambient lighting conditions. According to a second exemplary embodiment of the present invention, a backlight may be projected through a filter that may adapt to various ambient lighting conditions. In yet another exemplary embodiment of the present invention, a combination of the display window and the filter may be used for the various ambient lighting conditions. That is, the exemplary embodiments of the present invention provide an adapted display that shows data of a display to a user by first adapting to any ambient lighting condition via the window, the filter, or a combination thereof, thereby optimizing (e.g., by clarifying) the content viewed by the user on the display by improving contrast and readability. The display window and the filter will be discussed in more detail below.

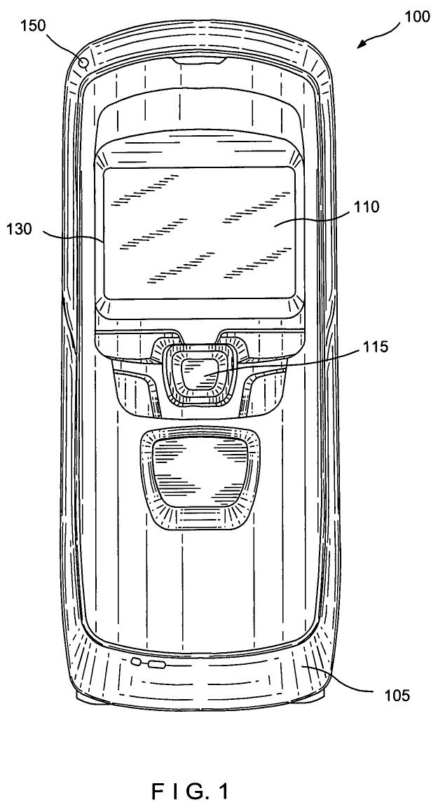

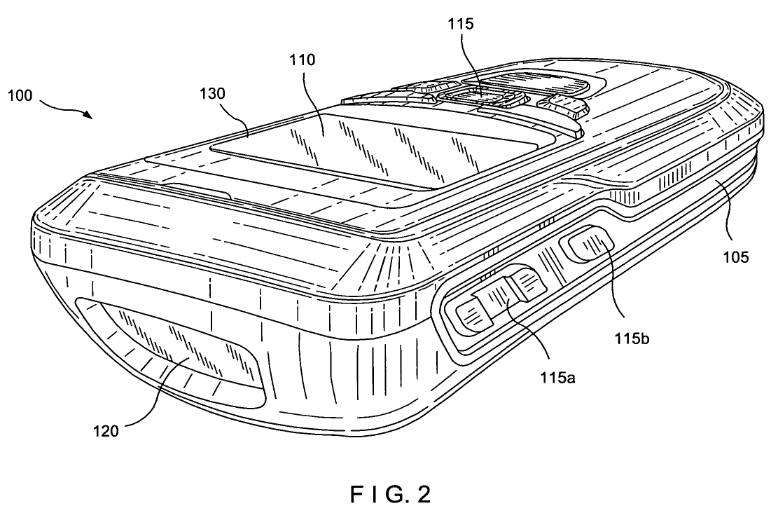

FIG. 1 shows a top view of a mobile device 100 according to an exemplary embodiment of the present invention and FIG. 2 shows a perspective view of the mobile device 100 of FIG. 1. It should be noted that the use of the mobile device 100 is only exemplary. The present invention may be applied to any system that uses a display including the examples cited above.

In the exemplary embodiment of FIG. 1, the mobile device 100 includes a housing 105, a display 110, a data input arrangement 115, and a window 130. The housing 105 is a casing that holds at least partially the components of the mobile device 100. The housing 105 may include an opening. The display 110 provides a visual interface for the user. The display may be situated at least partially in the opening of the housing. The display 110 will be discussed in more detail below. The data input arrangement 115 provides a mechanism for a user to input data for a plurality of functionalities available on the mobile device 100. The window 130 may be transparent to allow a user to view the contents of the display 110 while providing a protective surface to prevent damage to the display 110. When the display 110 may receive inputs from a user (e.g., touch screen), the window 130 may be adapted to facilitate this function. The mobile device 100 may further include, for example, a light sensor 150 that determines a relative ambient lighting condition.

In the exemplary embodiment of FIG. 2, the mobile device 100 further includes a data acquisition device (“DAD”) 120 (e.g., laser-based scanner, barcode scanner, image capturing device, etc.) along a top side of the mobile device 100. It should be noted that the DAD 120 is only exemplary and is used to indicate that the mobile device 100 may include further hardware devices disposed on or in the housing 105 to increase the available functionalities. Furthermore, it should be noted that the disposition of the DAD 120 on the top side of the mobile device 100 is only exemplary and may be disposed in or on any location of the mobile device 100. In the exemplary embodiment of FIG. 2, the mobile device 100 further includes a side data input arrangement 115a/b. The side data input arrangement 115a/b may be used to activate/deactivate hardware devices such as the DAD 120 (e.g., via 115b), scroll through menus (e.g., via 115a), etc. Furthermore, it should be noted that the side data input arrangement 115a/b is only exemplary and is used to indicate that the mobile device 100 may include data input arrangements anywhere on the mobile device 100.

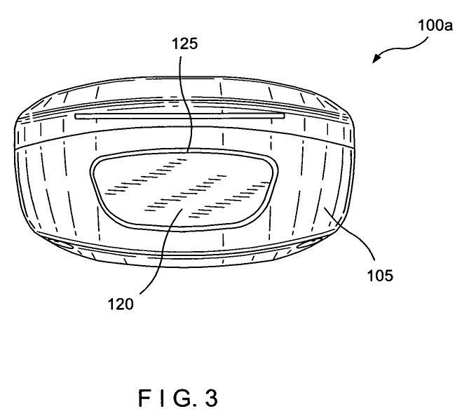

FIG. 3 shows a top view of a mobile device 100a according to another exemplary embodiment of the present invention. The mobile device 100a includes substantially the same components as the mobile device 100 of FIGS. 1-2. However, in addition, the mobile device 100a includes a slot 125 disposed on a top side of the MU 100a (e.g., near a location of the DAD 120). According to the exemplary embodiments of the present invention, the slot 125 may allow the window 130, the filter, and/or the combination thereof to be inserted. It should be noted that the use of the top side is only exemplary and the slot 125 may be disposed on any periphery of the mobile device 100a. The slot 125 will be discussed in more detail below. The slot 125 may further be coupled to a closing mechanism (not shown) to prevent inadvertent removal of the window 130 and/or the filter from the slot 125. For example, the slot 125 may include a hinge with a flap that opens to insert/remove the window 130 and/or the filter. The slot 125 may also include a separate lid that may be removed to insert/remove the window 130 and/or the filter.

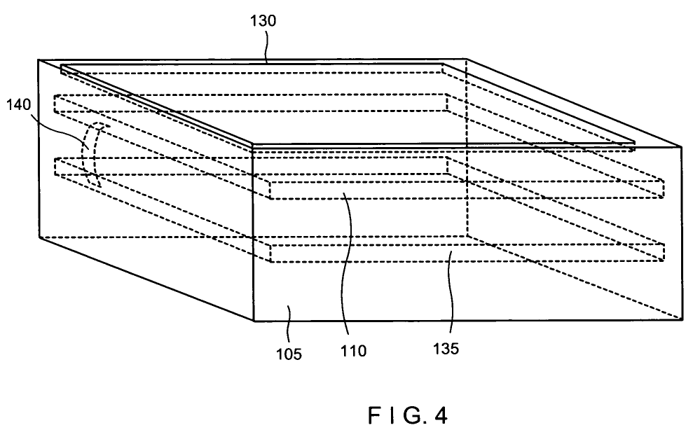

FIG. 4 shows a first inner view of the mobile device 100 of FIGS. 1-2. Specifically, FIG. 4 shows the first exemplary embodiment of the present invention where the window 130 adapts to the various lighting conditions. In this exemplary embodiment, the inner components for the mobile device 100 include the display 110, the window 130, a processor 135, and a data cable 140. As discussed above, these components may be on or in the housing 105, either partially or wholly. Furthermore, the window 130 may be at least partially within the opening of the housing 105. It should be noted that the mobile device 100 may include further components. For example, the DAD 120, an antenna, a memory, etc. may be included within the mobile device 100. In addition, further hardware components may be connected (e.g., hardwired, wirelessly) to the mobile device 100. The window 130 may be transparent to allow the data shown on the display 110 to be viewable by the user. The data cable 140 connects the processor 135 to the display 110 and facilitates an exchange of data signals.

As discussed above, the viewable content shown on the display 110 through the window 130 is affected by the ambient lighting conditions in which the mobile device 100 is used. The window 130 may provide a mechanism to work in conjunction with PMDs and the white backlight associated therewith. The window 130 may serve as a protective layer for the display 110. Therefore, the window 130 may be relatively thick (e.g., 5-10 mm) when the mobile device is used in a harsh environment while a relatively thin window 130 (e.g., 1-5 mm) may be used in a mild environment. Furthermore, the thickness may be dependent on the material in which the window 130 is composed. For example, a transparent, rigid polymer may be thinner while still offering the necessary protection. In another example, an elastomer may be thicker to offer the necessary protection. It should be noted that the thickness of the window 130 may be dependent on other factors such as if the mobile device utilizes a touch screen (e.g., window 130 is thinner to receive touch inputs), etc.

In one exemplary embodiment pertaining to insufficient ambient lighting conditions, the window 130 may absorb the blue component (450-495 nm) of the white backlight, thereby imparting to the window 130 a yellow appearance (570-590 nm). That is, the ambient lighting condition is poor (second predetermined condition where a high ambient light condition is a first predetermined condition). It should be noted that the window 130 may be manufactured according to the exemplary embodiment to be originally clear and consequently exhibit the yellow appearance when the blue component is absorbed. Those skilled in the art will understand that when a certain color is absorbed, another color is usually reflected. Through the absorption of the color affecting contrast (e.g., blue) in backlights, the display 110 has increased contrast and readability of contents shown for the user. Those skilled in the art will also understand that with different types of backlights, different colors may be absorbed/reflected. The present invention may also incorporate the different types of backlights. Furthermore, the use of a window 130 that is originally clear and turns yellow is only exemplary. Those skilled in the art will understand that the window 130 may be originally yellow tinted to absorb the blue component.

In another exemplary embodiment, the window 130 may provide a mechanism to work in conjunction with the PMD in a sufficient ambient lighting condition. That is, the ambient lighting condition is high (first predetermined condition). In cases where the mobile device 100 is used in various ambient lighting conditions, a user may find situations where one environment has high ambient light and another environment has low ambient light. With sufficient ambient lighting conditions, the window 130 that is clear (i.e., no color) may be preferable to a tinted window (e.g., yellow tint). Thus, after utilizing, for example, the window 130 with a yellow tint, the window 130 with the tint may be altered, manually or automatically, to the window 130 that is clear. The altering of the window 130 will be described in more detail below.

The altering of the window 130 may be done in various manners. In the exemplary embodiment shown in FIG. 4, the window 130 may be removed directly from the housing 105. For example, the housing 105 may include an arrangement around a border where the window 130 is disposed. This arrangement may include, for example, a lock, an adhesive, clips, etc. In another exemplary embodiment, the removal of the window 130 may not be necessary. For example, if the mobile device 100 includes light sensors to receive ambient lighting condition data, the processor 140 may determine if the ambient lighting is beyond a threshold value. The window 130 may include a mechanism to alter the tint. For example, the window 130 may be manufactured with a photoreactive polymer that alters the tint from a clear one to a yellow one. Thus, depending on the ambient lighting conditions, the window 130 may exhibit a clear or yellow tint.

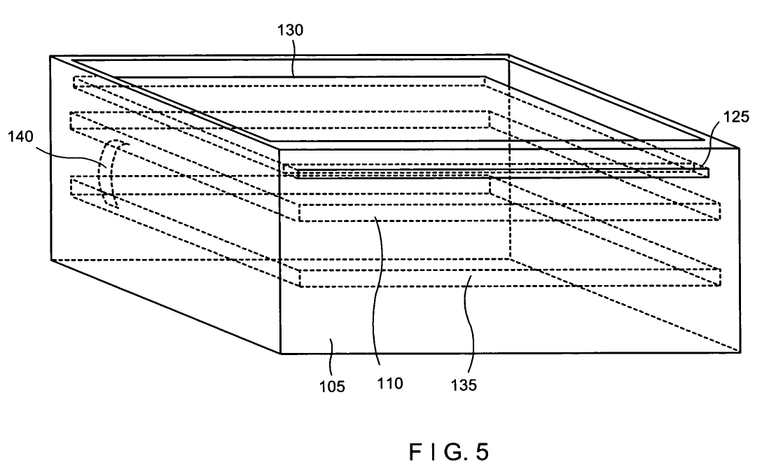

FIG. 5 shows a second inner view of the mobile device 100a of FIG. 3. FIG. 5 includes substantially the same components as the first inner view of the mobile device 100 of FIG. 4. However, FIG. 5 further illustrates the slot 125 of FIG. 3. That is, in this exemplary embodiment, the window 130 may be slid out of the slot 125. For example, when the window 130 that is tinted is being used and the user finds sufficient ambient lighting conditions, the window 130 that is tinted may be removed via the slot 125 to insert the window 130 that is clear into the slot 125. This exemplary embodiment may include similar arrangements to hold the window as discussed above with reference to the first inner view of the mobile device 100 of FIG. 1. Again, it should be noted that the mobile device 100a may also include the functionality to alter the tint of the window 130. In such an embodiment, the user may not be required to swap the window 130. The slot 125 may also be used to remove a damaged window to be replaced with a new one.

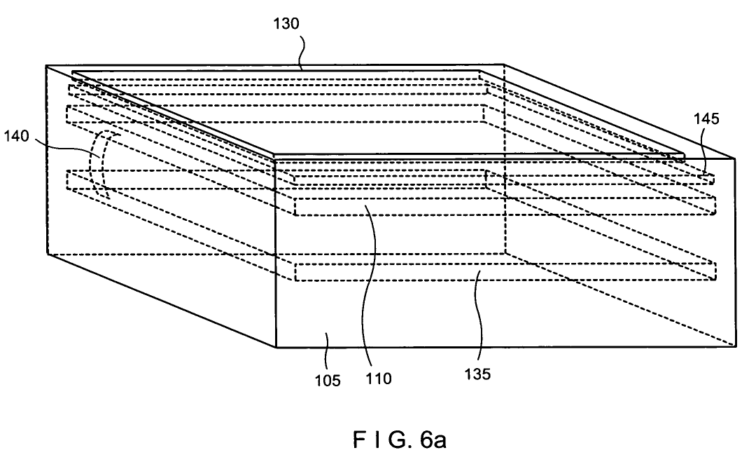

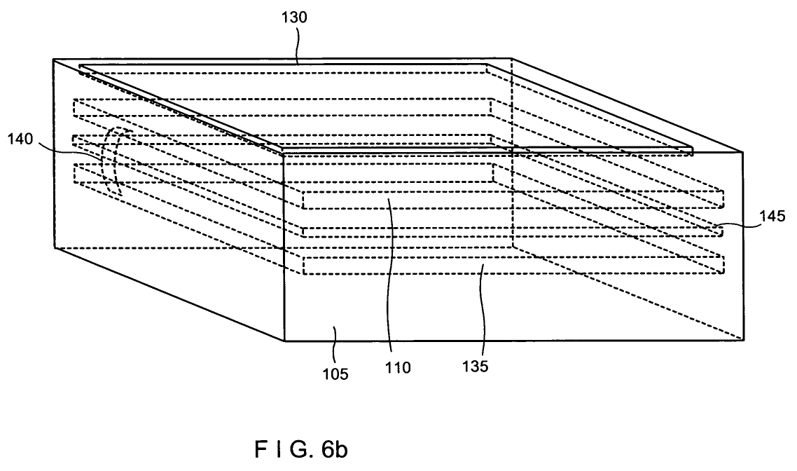

FIG. 6a shows a third inner view of the mobile device 100 of FIGS. 1-2. Specifically, FIG. 6a shows the second exemplary embodiment of the present invention where the filter 145 adapts to the various lighting conditions. In this exemplary embodiment, the inner components for the mobile device 100 include substantially similar components as those described above with reference to FIGS. 4-5. For example, the exemplary embodiment of FIG. 6a includes the display 110, the window 130, the processor 135, and the data cable 140. This exemplary embodiment further includes a filter 145. The filter 145 may be disposed between the display 110 and the window 130. Another embodiment may include the filter 145 disposed between the backlight source and the display 110 as shown in FIG. 6b. Furthermore, the filter 145 may also be at least partially within the opening of the housing 105. Because the exemplary embodiment utilizes the filter 145, the window 130 may be a window that is transparent to facilitate a user from viewing the contents of the display 110. The filter 145 may be, for example, a yellow film, a transparent yellow window, etc. As a film, the filter 145 may be thin (e.g., up to 1 mm). As a window, the filter 145 may be slightly thicker (e.g., 1-2 mm). The filter 145 may exhibit an area substantially similar to the window 130 or the display 110. That is, the filter 145 has an area that covers the readable area of the display 110 or the window 130. It should again be noted that the mobile device 100 may include further components such as the DAD 120.

In the exemplary embodiment of FIG. 6a, the filter 145 may provide a mechanism to work in conjunction with PMDs and the white backlight associated therewith. The filter 145 may function substantially similar to the window 130 described with reference to the exemplary embodiments of FIGS. 4-5. For example, the filter 145 may be manufactured to absorb blue light using a substantially similar photoreactive polymer used in the exemplary embodiment where the window 130 adapts to the environment. The filter 145 may also be manufactured of similar materials used for the window 130. For example, when the filter 145 is a window, the filter 145 may be composed of a transparent, rigid polymer. When the filter 145 is a film, the filter 145 may be composed of an elastomer. As discussed above, the blue component within a white backlight may affect the readability of the display 110. Thus, prior to the data of the display 110 being visible through the window 130, the filter 145 may absorb the blue component so that a user may view the data clearly. This absorption of the blue component may occur prior to the backlight passing through the display 110 or the window 130. In addition, the filter 145 may be tuned more precisely to absorb the necessary component that increases contrast and readability. For example, the backlight may be produced with light emitting diodes (LEDs). However, altering the color of LEDs is limiting due to the available LED emission spectra.

In either embodiment, the user has an increased contrast and readability of the data on the display 110. It should be noted that the filter 145 may also be connected to the processor via the data cable 140. Through this electrical connection, the filter 145 may be activated to absorb the blue component. The electrical connection may also allow a user to manually activate the filter 145 in certain environments while opting to keep the filter 145 inactive in other environments. However, it should be further noted that the filter 145 may automatically be designed to activate depending on light intensities, ambient lighting, etc.

It should be noted that the filter 145 may also have substantially similar further properties as the window 130. As discussed above, the component that is absorbed may be different given a particular environment. Thus, the filter 145 may absorb other components of the backlight. The filter 145 may be manually swapped by the user or the filter 145 may include a color changing property. Therefore, the filter 145 may also perform the various methods to increase contrast and readability that the window 130 may perform.

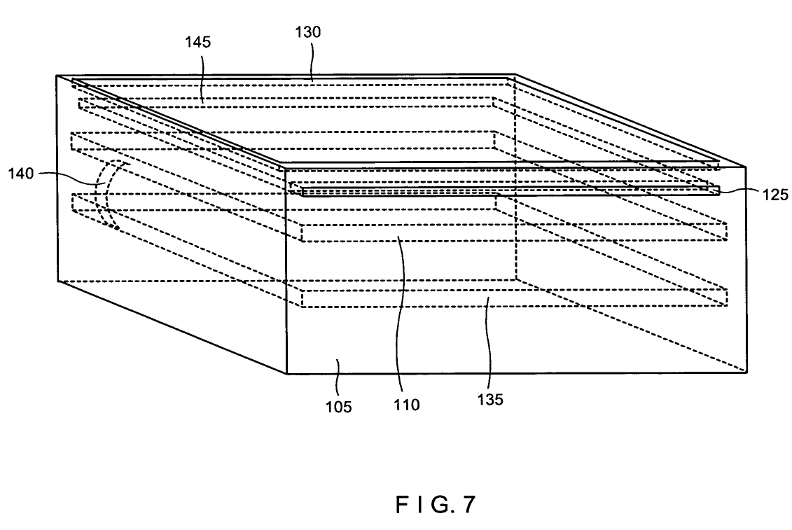

FIG. 7 shows a fourth inner view of the mobile device 100a of FIG. 3. FIG. 7 includes substantially the same components as the first inner view of the mobile device 100 of FIG. 6a. However, FIG. 7 further illustrates the slot 125 of FIG. 3. That is, in this exemplary embodiment, the filter 145 may be slid out of the slot 125. Therefore, similar to the insertion/removal of the window 130 using the slot 125 of FIG. 4, the filter 145 may be inserted/removed depending on the lighting conditions of the environment in which the mobile device is present. In addition, damaged filters may be removed using the slot 125.

As discussed above, the present invention may also provide a combination of a tint for the window 130 and the filter 145. In such an embodiment, a configuration substantially similar to the one described with reference to FIGS. 6-7 may be used. However, the window 130 may also include the blue component absorptive properties. This scenario may be advantageous if, for example, the filter 145 cannot absorb the entire blue component. Since the window 130 is disposed at a farther distance from the backlight relative to the filter 145, the window 130 may further absorb the blue component that was not absorbed by the filter 145.

It should be noted that the use of a yellow tint for the window 130 and/or the filter 145 is only exemplary. The yellow tint assumes that the insufficient lighting conditions are a lack of white light. However, the insufficient lighting conditions may be the presence of only, for example, red light, such as in a dark room. Thus, depending on the insufficient lighting conditions, different tints for the window 130 and/or the filter 145 may be preferable to optimize the clarity of the display 110. The present invention may involve using various windows 130 and/or filters 145 with various tints or may include the mechanism to alter the tint accordingly upon receiving the ambient lighting conditions from light sensors. Therefore, it is further noted that the tint of the window 130 and/or filter 145 may also include, red, violet, orange, green, etc. As described above with the dark room, the tint may be dependent on a predominant color of the ambient lighting condition. For example, if the predominant color of the ambient lighting condition is orange, then the tint may be green.

It should also be noted that the use of a tinted window and/or filter and white backlight are only exemplary. The present invention may also alter the color of the backlight to work with a clear window. For example, in an insufficient ambient lighting condition, the backlight may be yellow, thereby operating as if the backlight is white and the display window is yellow. The display may include a set of LEDs that may emit multiple colors. The backlight may use the LEDs to provide illumination for the display. Thus, using a static, clear window, the backlight may be adjusted to a color depending on the ambient lighting conditions.

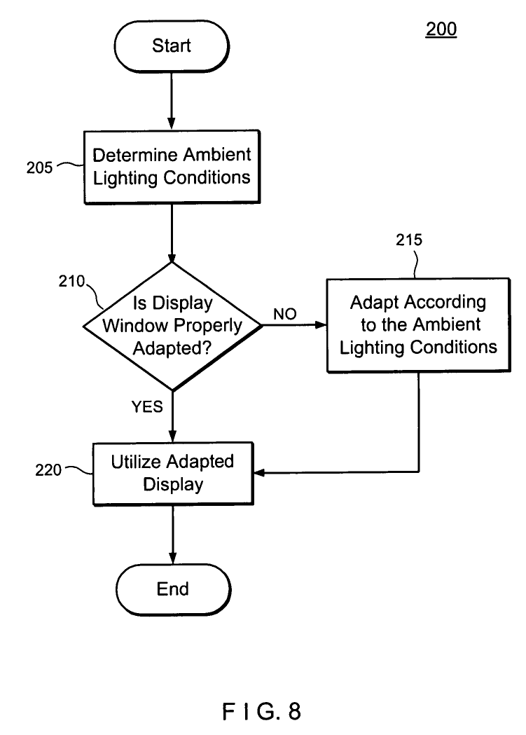

FIG. 8 shows a method 200 for optimizing visualization according to an exemplary embodiment of the present invention. The method 200 may be applied to any embodiment where the optimization of visualization is performed by the display window and/or the filter. The method 200 will be described with reference to the components of FIGS. 1-7.

First, the currently existing ambient lighting conditions are determined (step 205). The determining of the ambient lighting conditions may be performed in various ways. For example, as discussed above, a user may readily identify the ambient lighting conditions. Also as discussed above, light sensors may be disposed on a periphery of the housing 105 of the mobile device 100 that transmits ambient lighting data to the processor, thereby finding the ambient lighting conditions.

Once the ambient lighting conditions are found in step 205, the method continues to step 210 where a determination is made whether the display window and/or the filter is properly adapted to the ambient lighting conditions. For example, the window 130 and/or the filter 145 that is tinted may be more appropriate in poor ambient lighting conditions since a white backlight is utilized. Also, the window 130 and/or the filter 145 that is clear may be more appropriate in high ambient lighting conditions.

If step 210 determines that the display window and/or the filter is appropriate for the ambient lighting conditions, the method 200 continues to step 220 where the display window and/or the filter currently set up is utilized. The display window and/or the filter may provide the adapted display for the user. If step 210 determines that the display window and/or filter is inappropriate for the ambient lighting conditions, the method 200 continues to step 215 where the display window and/or filter is adapted according to the ambient lighting conditions. As discussed above, the adaptation of the display window and/or filter may be performed manually by the user or automatically by the processor. For example, using the slot 125, the user may swap out the display window and/or filter depending on the ambient lighting conditions. Also, if the window 130 and/or filter 145 is equipped with color altering properties, upon the processor finding the ambient lighting conditions (step 205), the window 130 and/or the filter 145 may be adjusted with an appropriate tint. Once the display window and/or filter is properly adapted, the method 200 proceeds to step 220 where the display window and/or filter is utilized.

The present invention affords further advantages over conventional mobile devices. With PMDs, the window 130 improves the clarity of the display in any ambient lighting condition. In areas with bright lights (i.e., high ambient light), a clear display may be used. In areas with dim lights (i.e., low ambient light), a tinted display may be used. The tint may also be adjusted depending on the type of ambient light that is present. A user may easily swap out windows or the processor may determine the appropriate tint for the window. It should be noted that the above described advantages are only exemplary and that other advantages exist for the window 130.

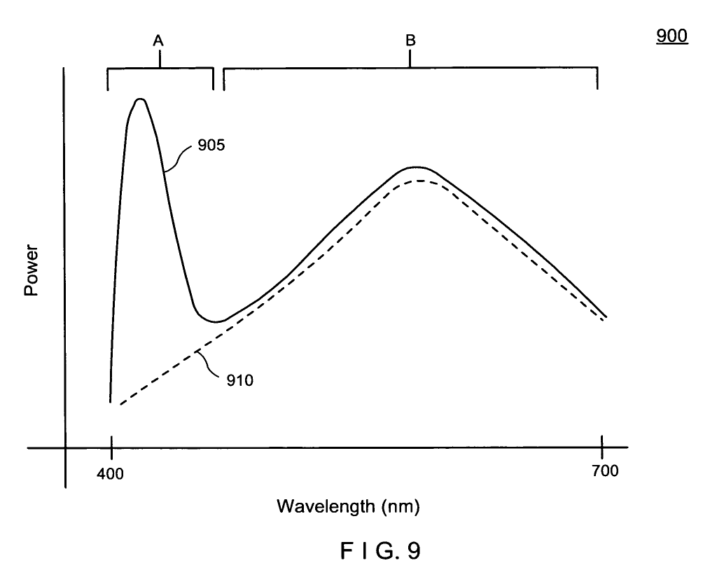

FIG. 9 shows a graph 900 when using the adapted display according to an exemplary embodiment of the present invention. As discussed above, the adapted display is the result of using the display 110 with either the window 130 or the filter 145 that adapts to the various ambient lighting conditions. The graph 900 shows a relationship between the wavelength of the backlight that is white versus power in transmission. The power in transmission is directly related to contrast and readability of the display. The white backlight includes the entire visible spectrum (e.g., wavelengths from 400 nm to 700 nm). In the first part A of the graph 900, colors that are not often used exist such as red, orange, etc. In the second part B of the graph 900, colors that are more often used exist such as green, blue, indigo, etc

Curve 905 indicates the relationship with wavelength and power for the backlight. Curve 910 indicates the relationship with wavelength and power when using the adapted display. Using the exemplary embodiments of the present invention, the power is substantially equivalent between the backlight and the adapted display in the second part B. As a result, a user has increased contrast and readability of the display.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a housing;
a display situated at least partially in an opening of the housing; and
an adaptive device disposed at least partially one of within the housing and in the opening, the adaptive device having a property to improve a visibility of the display, the property being related to an ambient lighting condition.

2. The mobile device of claim 1, wherein the adaptive device is one of a window and a filter.

3. The mobile device of claim 2, wherein the window is disposed above the display.

4. The mobile device of claim 2, wherein the filter is disposed above the display.

5. The mobile device of claim 2, wherein the filter is disposed below the display.

6. The mobile device of claim 1, wherein the property is adjusted as a function of the ambient lighting condition.

7. The mobile device of claim 5, wherein the adjustment is automatically adapting the adaptive device.

8. The mobile device of claim 1, further comprising:
a slot disposed on a periphery of the housing facilitating a manual swapping of the adaptive device with a second adaptive device, the second adaptive device having a second property relating to a second ambient lighting condition.

9. The mobile device of claim 1, wherein when the ambient lighting condition corresponds to a first predetermined condition, the adaptive device utilizes a clear tint.

10. The mobile device of claim 1, further comprising:
a backlight which is activated when the lighting condition corresponds to a second predetermined condition.

11. The mobile device of claim 10, wherein when the ambient lighting condition corresponds to the second predetermined condition, the adaptive device utilizes a colored tint.

12. The mobile device of claim 11, wherein the colored tint is yellow when the backlight is white.

13. The mobile device of claim 11, wherein the colored tint is one of red, violet, orange, and green corresponding to a predominant color of the ambient lighting condition.

14. A method for optimizing visualization, comprising:
determining an ambient lighting condition; and
adjusting a property of an adaptive device which is at least partially disposed within a housing of a mobile device according to the ambient lighting condition to improve a visibility of a display situated in the housing.

15. The method of claim 14, wherein the ambient lighting condition is determined one of manually by a user and automatically by light sensors disposed on a periphery of the housing.

16. The method of claim 14, wherein the adaptive device is adjusted manually.

17. The method of claim 14, wherein the adaptive device is adjusted automatically.

18. The mobile device of claim 14, wherein the property is a clear tint when the ambient lighting condition is corresponds to a first predetermined condition.

19. The method of claim 13, further comprising:
activating a backlight when the lighting condition corresponds to a second predetermined condition.

20. The method of claim 19, wherein the property is a colored tint when the ambient lighting condition corresponds to the second predetermined condition.

21. The method of claim 20, wherein the colored tint is yellow when the backlight is white.

22. A mobile device, comprising:
a housing;
a displaying means for displaying an image, the displaying means being situated at least partially in an opening of the housing; and
an adaptive means for improving a visibility of the displaying means by adapting to an ambient lighting condition, the adaptive means being disposed at least partially one of within the housing and in the opening.
